(19) United States
(12) Patent Application Publication
(10) Pub. No.: US 2010/0218232 A1
(43) Pub. Date: Aug. 26, 2010

(54) SIGNALLING OF AUXILIARY INFORMATION THAT ASSISTS PROCESSING OF VIDEO ACCORDING TO VARIOUS FORMATS

(75) Inventors: Arturo A. Rodriguez, Norcross, GA (US); Benjamin M. Cook, Flowery Branch, GA (US)

Correspondence Address: MERCHANT & GOULD;SCIENTIFIC ATLANTA, A CISCO COMPANY, P.O. BOX 2903, MINNEAPOLIS, MN, 55402-0903, US

(73) Assignee: Cisco Technology, Inc., San Jose, CA (US)

(21) Appl. No.: 12/713,153

(22) Filed: Feb. 25, 2010

Related U.S. Application Data
(60) Provisional application No. 61/155,505, filed on Feb. 25, 2009.

(51) Int. Cl. H04N 7/173; H04N 7/12

(52) U.S. Cl. 725/118; 375/240.25; 375/E07.027

(57) ABSTRACT

In one embodiment, receiving at a video stream receive-and-process (VSRP) device auxiliary information corresponding to a video stream, the auxiliary information corresponding to a fixed quantity of framestores to be allocated in a decoded picture buffer; receiving at the VSRP device the video stream comprising a first portion of compressed pictures having a first picture format and a second portion having a second picture format during transmission over a given channel, wherein the first compressed picture of the second portion of compressed pictures is the first compressed picture in the video stream after the last compressed picture of the first portion of compressed pictures; and decoding the first and second portions of the video stream with the fixed quantity of framestores according to the received auxiliary information and outputting the first and second decoded portions of the video stream with a fixed output resolution per the received auxiliary information.

### CROSS REFERENCE TO RELATED APPLICATION

The present application claims priority to and the benefit of provisional patent application having Ser. No. 61/155,505, filed on Feb. 25, 2009, and incorporated herein by reference in its entirety.

### TECHNICAL FIELD

This disclosure relates in general to television systems, and more particularly, to video processing in television systems.

### BACKGROUND

In network systems such as subscriber television systems, a digital home communication terminal (“DHCT”), otherwise known as the set-top box, is capable of providing video services connected to the subscriber television system, and is typically located at the user's premises and connected to the subscriber television system, such as, for example, a cable or satellite network. The DHCT includes hardware and software necessary to provide digital video services to the end user with various levels of usability and/or functionality. One of the features of the DHCT includes the ability to receive and decompress a digital video signal in a compressed format, wherein such compression may be in accordance with the Advanced Video Coding (AVC) standard, and the resulting streams are referred to herein as AVC streams. The AVC standard generally has a rich set of compression tools and can exploit temporal redundancies among pictures in more elaborate and comprehensive ways than prior video coding standards. Such advanced features also impose considerable consumption of processing resources and re-configuration of resources.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram that illustrates an example environment in which video processing (VP) systems and methods may be implemented.

FIG. 2A is a block diagram of an example embodiment of a video stream receive-and-process (VSRP) device comprising an embodiment of a VP system.

FIG. 2B is a block diagram of an example embodiment of display and output logic of a VSRP device.

FIG. 3 is a flow diagram that illustrates one example VP method embodiment to process video based on auxiliary information received responsive to a channel change event or an acquisition of a video service (e.g., without requiring a channel change).

FIG. 4 is a flow diagram that broadly illustrates one example VP method embodiment comprising a VSRP device that allocates resources based on reception and interpretation of auxiliary information.

FIG. 5 is a flow diagram that illustrates one example VP method embodiment comprising plural VSRP devices that each receive and process video streams in different ways.

FIG. 6 is a flow diagram that broadly illustrates one example VP method embodiment comprising a VSRP device that allocates framestores based on reception and interpretation of auxiliary information.

### DESCRIPTION OF EXAMPLE EMBODIMENTS

### Overview

In one method embodiment, receiving at a video stream receive-and-process (VSRP) device auxiliary information corresponding to a video stream, the auxiliary information corresponding to a fixed quantity of framestores to be allocated in a decoded picture buffer; receiving at the VSRP device the video stream comprising a first portion of compressed pictures having a first picture format and a second portion having a second picture format during transmission over a given channel, wherein the first compressed picture of the second portion of compressed pictures is the first compressed picture in the video stream after the last compressed picture of the first portion of compressed pictures; and decoding the first and second portions of the video stream with the fixed quantity of framestores according to the received auxiliary information and outputting the first and second decoded portions of the video stream with a fixed output resolution in accordance with the received auxiliary information.

### Example Embodiments

Disclosed herein are various example embodiments of video processing (VP) systems and methods (collectively, referred to herein also as a VP system or VP systems) that convey and process auxiliary information delivered in, corresponding to, or associated with, a video stream. In one embodiment, the auxiliary information signals to a video stream receive-and-process (VSRP) device a fixed quantity of pictures to be used in a decoded picture buffer (DPB) (herein the pictures to be used in the DPB referred to also as DPB pictures), such as to store reference pictures and/or pictures yet to be displayed (e.g., output to a display). The fixed quantity of DPB pictures serves as a basis for the VSRP device in allocating a fixed number of framestores in an environment of changing picture formats (e.g., changing picture sizes) corresponding, e.g., to a change from the last compressed picture of a first portion of compressed pictures of the video stream to the first compressed picture in a second portion of compressed pictures that immediately follows the first portion. For instance, the native (or input to the encoder) picture resolution and size carried in the encoded video signal of a television service may be different than a picture format of the of the portion of the video stream corresponding to a commercial segment. The auxiliary information is included in the video stream in advance of the change in picture format.

In some embodiments, the fixed quantity of DPB pictures that is signaled by the auxiliary information is based on the largest picture size (in terms of total number of pixels in the spatial picture resolution) carried among the compressed pictures of a video stream. In a particular video service, the largest picture size among plural anticipated picture formats (in the video service) corresponds to a main picture format (e.g., the principal picture format of the television service or television channel). In some embodiments, the auxiliary information includes a main picture format among plural anticipated picture formats of a video service. The main picture format may include an interlaced output picture format. An interlaced output picture format includes one or more of the following: picture resolution (horizontal resolution and vertical resolution), frames per second, scan type (interlaced or progressive), and picture aspect ratio. The auxiliary information may also include the anticipated alternate picture formats to be included in the television service (e.g., the plural picture formats that may be present in the video stream). Alternate picture formats, such as one or more of the above picture formats or resolutions, may be inserted or provided in certain segments or intervals of the video stream of a television service. For instance, an advertisement segment may be inserted at a device, such as a splicing device. Such alternate picture formats in video signals may include local feeds (e.g., local to a headend in a subscriber television system), such as local or regional commercials, that are spliced into national feeds (e.g., broadcast network programming).

Herein, use of the terms “main video signal” refers to the picture format used in the respective portions of compressed pictures of a video stream that possess the intended main picture format in a transmitted video signal of a television service and “alternate video signal” refers to the picture format used in the respective portions of compressed pictures of a video stream that possess the alternate video signal format, such as in segments of the video stream or intervals of time when the main video signal is not present in the transmitted video signal of the television service.

One benefit of a framestore allocation based on the conveyed fixed number of DPB pictures is that their corresponding memory management at the VSRP device is facilitated. For instance, de-allocation and re-allocation of framestores in the midst of changing picture formats (e.g., via transmission of main and alternate video signals) is avoided. In the Advanced Video Coding (AVC) standard (herein, simply AVC), like in other compression standards or specifications such as MPEG-2 (Moving Picture Experts Group), content is transmitted according to various profiles and levels. For instance, in a typical broadcast environment, video is transmitted according to a main or high profile, where the profile basically sets the worst-case processing and/or resource requirements (e.g., maximum limits) for which a video stream can be processed (e.g., decoded and output) on a real-time basis. It also avoids wasteful simultaneous allocation of memory for the two picture formats. Levels impose constraints or boundaries in terms of size, such as a maximum bit rate and/or buffer sizes (e.g., the bit buffer or rather compressed picture buffer (CPB) size, decoded picture buffer (DPB) size, etc.). In AVC, the size of the DPB is not necessarily equal to the allowable number of frames (for reference pictures and pictures yet to be output), but rather, is based on the maximum amount of memory (e.g., in bytes or mega-bytes (MB) or number of macroblocks) for the respective level. For instance, a level designation of Level 4.0 does not necessarily equate to four (4) reference pictures, but rather, refers to an amount of memory required by a compliant decoder to support any permissible combination of reference pictures and/or pictures that have yet to be displayed (e.g., pictures with output times in the future).

As an example, in AVC, a video signal may be received at a VSRP device as a 1920×1088 HD video signaled as Level 4.0, for which its DPB size contemplates a maximum of four (4) DPB framestores. Alternatively, a video signal may be received at the VSRP device at Level 4.0 according to a 1440×1088 picture format contemplating a maximum of five (5) frames in the DPB, and/or as a 1280×720 video signal that contemplates a maximum of nine (9) frames in the DPB. Variations or switching of picture formats in the video stream may occur (one or more times) during a transmitted television service, such as during an interval of a single broadcast program, such as when local commercials are provided in, or spliced into, one or more portions of the video stream, which imposes considerable difficulty to support on a real-time basis consumption of resources on memory and processing logic of the VSRP, and/or compromises the quality of the corresponding video presentation. Certain embodiments disclosed herein address the resource burden and/or video quality issue by implementing the allocation of resources required in the video decoder to be compliant to the specified level, and when the auxiliary information associated with the video stream is present. Further, according to the largest picture size among the plural anticipated picture sizes, the allocation of memory is such that a fixed, maximum number of DPB frames are allocated by the VSRP device for the particular largest picture size among the plural picture formats in accordance with a video coding specification or standard. Thus, the framestores are allocated and reserved as available for processing (e.g., decoding) compressed pictures of a video stream based on the largest picture size. For video streams conveyed in the same channel having smaller picture sizes (e.g., responsive to a change, or switch, or transition in video picture format), the same allocations persist, where each framestore is underutilized. However, for such video stream portions with smaller picture sizes than the largest picture size (among the plural anticipated picture formats), memory is not de-allocated and re-allocated to accommodate a larger number of DPB frames, albeit the same less amount of memory.

In some embodiments, the same or different auxiliary information conveys to a VSRP device that the intended picture format to be outputted corresponds to the picture format of the preferred and nonchanging main picture format, which may correspond to the predominant picture format of the video service or in the video stream. The signalling of auxiliary information in the video stream is periodically to enable proper initialization of decoding logic, reducing the video decoder set-up, and thus the overall channel change or acquisition time and hence circumventing or mitigating interruptions in the viewing experience.

In one embodiment, for infrequent or long times between picture format transitions, the periodicity of auxiliary information may differ (e.g., longer). For single or dual scheduled daily transition of picture formats in a video service, the auxiliary information is provided or signaled in the video service prior to the respective occurrence of the transition of picture formats in the video stream.

Auxiliary information is provided in the video stream prior to a change of picture formats in the video stream. For instance, when the auxiliary information is provided periodically, it is provided prior to the first picture of the second portion of compressed pictures of the video stream having a second picture format, where said first picture of the second portion is the first picture in the video stream that immediately follows the last picture of a first portion of compressed pictures of the video stream having a first picture format different than the second picture format.

These and/or other features and embodiments are described hereinafter in the context of an example subscriber television system environment, with the understanding that other multi-media (e.g., video, graphics, audio, and/or data) environments, including Internet Protocol Television (IPTV) network environments, cellular phone environments, and/or hybrids of these and/or other networks, may also benefit from certain embodiments of the VP systems and methods and hence are contemplated to be within the scope of the disclosure. It should be understood by one having ordinary skill in the art that, though specifics for one or more embodiments are disclosed herein, such specifics as described are not necessarily part of every embodiment.

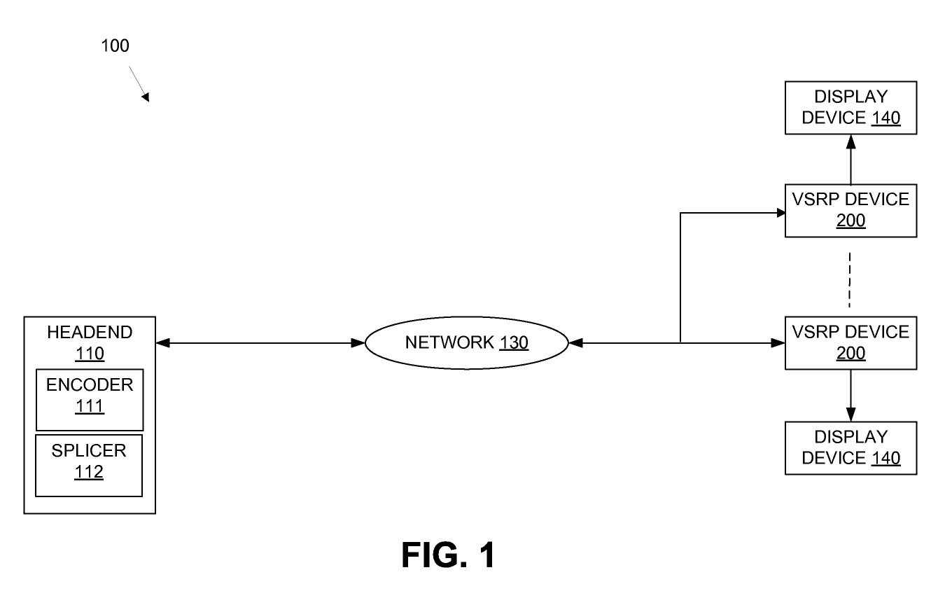

FIG. 1 is a high-level block diagram depicting an example environment in which one or more embodiments of a VP system are implemented. In particular, FIG. 1 is a block diagram that depicts an example subscriber television system (STS) 100. In this example, the STS 100 includes a headend 110 and one or more video stream receive-and-process (VSRP) devices 200. In some embodiments, one of the VSRP devices 200 may not be equipped with functionality to process auxiliary information that conveys picture format information, such as a main picture format, plural anticipated picture formats, a fixed number of DPB frames, the intended output picture format, and/or other processing-assistive information. The VSRP devices 200 and the headend 110 are coupled via a network 130. The headend 110 and the VSRP devices 200 cooperate to provide a user with television services, including, for example, broadcast television programming, interactive program guide (IPG) services, video-on-demand (VOD), and pay-per-view, as well as other digital services such as music, Internet access, commerce (e.g., home-shopping), voice-over-IP (VoIP), and/or other telephone or data services.

The VSRP device 200 is typically situated at a user's residence or place of business and may be a stand-alone unit or integrated into another device such as, for example, the display device 140, a personal computer, personal digital assistant (PDA), mobile phone, among other devices. In other words, the VSRP device 200 (also referred to herein as a digital receiver or processing device or digital home communications terminal (DHCT)) may comprise one of many devices or a combination of devices, such as a set-top box, television with communication capabilities, cellular phone, personal digital assistant (PDA), or other computer or computer-based device or system, such as a laptop, personal computer, DVD/CD recorder, among others. As set forth above, the VSRP device 200 may be coupled to the display device 140 (e.g., computer monitor, television set, etc.), or in some embodiments, may comprise an integrated display (with or without an integrated audio component).

The VSRP device 200 receives signals (video, audio and/or other data) including, for example, digital video signals in a compressed representation of a digitized video signal such as, for example, AVC streams modulated on a carrier signal, and/or analog information modulated on a carrier signal, among others, from the headend 110 through the network 130, and provides reverse information to the headend 110 through the network 130. As explained further below, the VSRP device 200 comprises, among other components, a video decoder and a reconfigurable decoded picture buffer (DPB) that in one embodiment is only reconfigured upon acquiring or starting a video source, such as when changing a channel or starting a VOD session, respectively, and further not reconfiguring the DPB in number of frames or size of frames upon receiving in the video decoder a change in picture format in the video stream of a video service, in accordance with received auxiliary information associated with the video stream.

The television services are presented via respective display devices 140, each which typically comprises a television set that, according to its type, is driven with an interlaced scan video signal or a progressive scan video signal. However, the display devices 140 may also be any other device capable of displaying video images including, for example, a computer monitor, a mobile phone, game device, etc. In one implementation, the display device 140 is configured with an audio component (e.g., speakers), whereas in some implementations, audio functionality may be provided by a device that is separate yet communicatively coupled to the display device 140 and/or VSRP device 200. Although shown communicating with a display device 140, the VSRP device 200 may communicate with other devices that receive, store, and/or process video streams from the VSRP device 200, or that provide or transmit video streams or uncompressed video signals to the VSRP device 200.

The network 130 may comprise a single network, or a combination of networks (e.g., local and/or wide area networks). Further, the communications medium of the network 130 may comprise a wired connection or wireless connection (e.g., satellite, terrestrial, wireless LAN, etc.), or a combination of both. In the case of wired implementations, the network 130 may comprise a hybrid-fiber coaxial (HFC) medium, coaxial, optical, twisted pair, etc. Other networks are contemplated to be within the scope of the disclosure, including networks that use packets incorporated with and/or are compliant to MPEG-2 transport or other transport layers or protocols.

The headend 110 may include one or more server devices (not shown) for providing video, audio, and other types of media or data to client devices such as, for example, the VSRP device 200. The headend 110 may receive content from sources external to the headend 110 or STS 100 via a wired and/or wireless connection (e.g., satellite or terrestrial network), such as from content providers, and in some embodiments, may receive package-selected national or regional content with local programming (e.g., including local advertising) for delivery to subscribers. The headend 110 also includes one or more encoders (encoding devices or compression engines) 111 (one shown) and one or more video processing devices embodied as one or more splicers 112 (one shown) coupled to the encoder 111. In some embodiments, the encoder 111 and splicer 112 may be co-located in the same device and/or in the same locale (e.g., both in the headend 110 or elsewhere), while in some embodiments, the encoder 111 and splicer 112 may be distributed among different locations within the STS 100. For instance, though shown residing at the headend 110, the encoder 111 and/or splicer 112 may reside in some embodiments at other locations such as a hub or node. The encoder 111 and splicer 112 are coupled with suitable signalling or provisioned to respond to signalling for portions of a video service where commercials are to be inserted.

The VP systems and methods disclosed herein are applicable to any video compression method performed according to a video compression specification allowing for at least one type of compressed picture that can depend on the corresponding decompressed version of each of more than one reference picture for its decompression and reconstruction. For example, the encoder 111 may compress an inputted video signal (e.g., provided by a service provider in one of any of several forms, image capture device, a headend server, etc.) according to the specification of the AVC standard and produce an AVC stream containing different types of compressed pictures with a common picture format, some that may have a first compressed portion that depends on a first reference picture for their decompression and reconstruction, and a second compressed portion of the same picture that depends on a second and different reference picture. Since the compressed video (and audio) streams are produced in accordance with the syntax and semantics of a designated video (and audio) coding method, such as, for example, AVC, the compressed video (and audio) streams can be interpreted by an AVC-compliant decoder for decompression and reconstruction at the time of reception, at a future time, or both.

In one embodiment, each AVC stream is packetized into transport packets according to the syntax and semantics of transport specification, such as, for example, MPEG-2 transport defined in MPEG-2 systems. Each transport packet contains a header with a unique packet identification code, or PID, associated with the respective AVC stream. In one implementation, the encoded audio-video (A/V) content for a single program may be the only program carried in a transport stream (e.g., one or more packetized elementary stream (PES) packet streams sharing a common time base for the same video service), and in other implementations, the encoded A/V content for multiple programs may be carried as multiplexed programs in an MPEG-2 transport stream, each program associated with its own respective time base.

In IPTV implementations, the program or transport stream may be further encapsulated in Internet protocol (IP) packets, and delivered via multicast (e.g., according to protocols based on Internet Group Management Protocol (IGMP), among other protocols), or in other cases such as video-on-demand (VOD), via unicast (e.g., Real-time Streaming Protocol or RTSP, among other protocols). For instance, multicast may be used to provide multiple user programs destined for many different subscribers. Communication of IP packets between the headend 110 and the VSRP devices 200 may be implemented according to one or more of a plurality of different protocols or communication mechanisms, such as User Datagram Protocol (UDP)/IP, Transmission Control Protocol (TCP)/IP, transport packets encapsulated directly within UDP or Real-time Transport Protocol (RTP) packets, among others.

The encoder 111 provides a compressed video stream (e.g., in a transport stream) to the splicer 112 while both receive signals or cues that pertain to splicing or digital program insertion. In some embodiments, the encoder 111 does not receive these signals or cues. In one embodiment, the encoder 111 and/or splicer 112 are further configured to provide auxiliary information in the transport layer of the video stream to convey to the VSRP devices 200 instructions corresponding to picture format information as previously described, such as a main picture format, plural anticipated picture formats, a fixed number of DPB frames, the intended output picture format, and/or other processing-assistive information. A fixed quantity of framestores corresponds to a particular picture size. For instance, for a particular television service (e.g., corresponding to a given channel, such as FOX news or ESPN), the auxiliary information informs the VSRP device 200 of the main and possible different (alternate) anticipated picture formats in the video stream and/or the number of DPB frames and the single picture size for each DPB frame, which are based on the largest picture size among the main and alternate picture formats contemplated for the channel; thus informing the decoding logic of the VSRP device 200 to expect such format changes at any time, such as transitions of spliced video segments, so that the decoding logic can pre-allocate worst-case resources (such as framestores of worst case horizontal and vertical resolutions and the number of framestores in memory). In one embodiment, the largest picture size is provided to the VSRP device 200 in the auxiliary information associated with the video stream. In some embodiments, the largest picture size is determined by the VSRP device 200 from plural picture formats provided in the auxiliary information. In one embodiment, the largest picture size corresponds to the picture size of one of the anticipated picture formats in the video stream of the video source. In some embodiments, the largest picture size corresponds to the picture size obtained from the maximum horizontal picture resolution among the plural anticipated picture formats, and the maximum vertical picture resolution among the anticipated picture formats. Note that the maximum may result from two different anticipated picture formats. The auxiliary information can be embodied in one or more of various mechanisms or layers, such as in the form of a descriptor in a PMT, as explained further below.

The splicer 112 splices one or more video streams (e.g., provided by a video source separate from the video source that provides the first video stream) into designated portions of the video stream provided by the encoder 111 according to one or more suitable splice points, and/or in some embodiments, replaces one or more of the video sequences provided by the encoder 111 with other video sequences. Further, the splicer 112 may pass the auxiliary information provided by the encoder 111, with or without modification, to the VSRP device 200, or the encoder 111 may provide the auxiliary information directly (bypassing the splicer 112) to the VSRP device 200. The output of the splicer 112 is a video stream that includes a first portion of compressed pictures having a first picture format that was provided by the encoder 111, followed by a second portion of compressed pictures having a second picture format that is provided by the splicer 112. In one embodiment, the second picture format provided by the splicer 112 for a first splice operation equals the first picture format and for a second splice operation, the splicer 112 provides a third picture format for a third portion of compressed pictures that is different than the first picture format provided by the encoder 111 in its compressed pictures.

The auxiliary information in the various embodiments described above may be embodied as a descriptor in a table (e.g., PMT), or in the form of bits or bytes. This feature enables the VSRP device 200 to set-up decoding logic and a display pipeline without interrogating the video coding layer to obtain the necessary information, hence shortening channel change time, and perhaps more importantly, without having to reconfigure the DPB or the intended output picture format. The auxiliary information in one embodiment may be configured to convey that a quantity of frames for use in the DPB (DPB frames) is to remain fixed for the currently tuned (or accessed) channel. In some embodiments, the auxiliary information may convey that the number or quantity K of DPB pictures is to remain constant (fixed) and equal to the maximum number of DPB frames corresponding to the maximum picture size expected for the level signaled in the video stream. In some embodiments, the value of K equals the maximum number of DPB frames corresponding to the maximum picture resolution for a video stream that has all encoded pictures with the same vertical resolution yet not the same horizontal resolution. For instance, for a video stream containing 1280×720 coded pictures and 960×720 coded pictures, K may be equal to nine (9). In some embodiments, the maximum DPB frames for 1280×720 may be fixed as six (6).

Note that in some embodiments, subsets of picture formats are included in the plural picture formats conveyed by the auxiliary information. In one embodiment, if a main video signal corresponds to a main picture format that is a downscaled horizontal picture resolution (e.g., 1440×1088 as opposed to 1920×1088), an alternate picture format corresponding to a commercial or spliced video stream may include the corresponding superior format (e.g., the native 1920×1088) as an alternate picture format. A picture format may be determined to be subsampled from the intended output picture format provided in the auxiliary information, the sample aspect ratio of the pictures, or both. The sample aspect ratio is provided in the video stream. In one embodiment, it is also provided in the auxiliary information. In some embodiments, using the example above, when the main picture format conveyed by the auxiliary information is 1440×1088, 1920×1088 is not explicitly included in the auxiliary information as an alternate, but rather, it is assumed (by the VSRP device 200) that 1920×1088 is an alternate. In addition, as indicated above, if signalling of the main picture format involves a downscaled resolution (e.g., horizontal resolution) less than the native or maximum horizontal resolution, the DPB is configured with framestores allocated to accommodate the maximum size of the largest picture format (e.g., 1920×1088 in this case). Note that one skilled in the art should understand that 1080 generally refers to the intended output picture format, which is different but corresponding to 1088 vertical resolution required to compress and decode pictures in memory.

Auxiliary information can be provided in a program or stream descriptor associated with the video program. In one embodiment, the auxiliary information is provided in a “main” descriptor loop that describes the whole program. In some embodiments, the descriptor loop is provided for each iteration of the elementary stream (ES) loop for each component (e.g., video). The descriptor may be provided in a loop providing associated information with the video component or stream of the video program. The video component is essentially the video elementary stream in a multiplex of streams corresponding to the video program carried in a transport stream, such as the MPEG-2 Transport Stream (in accordance with ISO-13818-1 MPEG-2 Systems). In one embodiment the auxiliary information is provided via a descriptor associated with the video program and carries information related to one or more the streams of the video program (e.g., a video elementary stream's picture format information, and an audio elementary stream's format information). In some embodiments, the auxiliary information is provided via a descriptor associated only with the video's elementary stream, and the location of the auxiliary information is at a location in the transport stream that conveys information associated with the video elementary stream. The descriptor may be provided by a construct such as:
[TAG (1 byte)] [LENGTH (1 byte)] [DATA]

In one embodiment, a specific TAG value is assigned to this particular type of auxiliary information, and the data carries the auxiliary information described herein (e.g., the picture formats, bitmap data fields that signal respectively corresponding alternative picture formats or picture sizes). In some embodiments, the auxiliary information is provided by a TAG value associated with the video codec used for compressing the picture in the video elementary stream, such as a tag that corresponds to auxiliary information for an AVC stream.

When the auxiliary information is provided via a descriptor in the video program loop or other mechanism that is associable with the corresponding video stream, the main output information may include audio format information to allow audio to switch from one principal audio format to alternate audio formats. Auxiliary information for audio may include codecs (e.g., AC-3, AAC, etc.), number of channels (e.g., stereo or surround), and/or other pertinent parameters. Auxiliary information providing principal formats for other media types and their allowed or expected alternate formats is also contemplated to be within the scope of the VP system embodiments.

In addition, the auxiliary information has positive ramifications in the context of the layer in which it is located, as well as where it is located in relation to the order of initializing decoding of an acquired video service or upon entering a transport stream of a video service. For instance, a descriptor with the PMT is at the very earliest stage of initializing the decoding pipeline and/or output pipeline for the acquired video service (e.g., channel), avoiding the need to parse all the encapsulating layers to find information in the video stream. In other words, the location of the auxiliary information according to certain embodiments described herein enables not only obtaining the information at a higher layer, but also at the very beginning of the first portion of information in the highest layer.

In some embodiments, the auxiliary information may be carried in the System Information (SI) data (e.g., in-band or out-of-band data that in some embodiments gives the channel line-up, with the channel numbers, session-IDs, frequencies, program numbers, and other per-channel characteristics). SI data may be in the form of ATSC A/65 PSIP (Program and system Information Protocol) data.

As an example of possible auxiliary information constructs (e.g., format of the descriptor), if there are sixteen (16) main formats, four (4) bits are assigned to signal the main format, and another sixteen (16) bits are sent to convey which of the sixteen (16) may be possible in the service. The parameters may be used to determine the size of the framestores for decoding, and also, to set-up the display pipeline (e.g., outputting), as explained below. In some embodiments, another nibble may be used that indicates the number of DPB frames. In addition, in some embodiments, the conveyed sizes cannot exceed a predetermined maximum picture size, or a predetermined maximum horizontal picture resolution and a predetermined maximum vertical picture resolution.

Continuing with further constructs for the auxiliary information, the main and alternate formats that comprise the anticipated picture formats in a video source may be signaled with a bitmap corresponding to one or more entries in the tables below. For instance, bits of a given bitmap correspond to one or more rows of the below tables. Table 1 corresponds to SD formats, Table 2 corresponds to HD formats, including two additional rows corresponding to 1080 P-60 Hz (or 50 Hz) picture formats. In some embodiments, the information of tables 1 and 2 may be expressed in a single table or tables in excess of the two described below, and additional picture formats and/or other information in general is contemplated (e.g., the information included in the tables below is not meant to be exhaustive).

TABLE 1
(SD)

| | | | | MaxFrameBuffers | | | | | |
|---|---|---|---|---|---|---|---|---|---|
| vertical | horizontal | PicWidth | PicHeight | Error! Reference | aspect_{—} | level_{—} | Display | Allowed | Progressive |
| size | size | (MBs) | (MBs) | source not found. | ratio_idc | idc | aspect ratio | frame rates | interlaced |
| 480 | 720 | 45 | 30 | 6 | 5 | 30 | 16:9 | 1, 2, 4, 5 | P |
| 480 | 720 | 45 | 30 | 6 | 3 | 30 | 4:3 | 1, 2, 4, 5 | P |
| 480 | 720 | 45 | 30 | 6 | 5 | 30 | 16:9 | 4, 5 | I |
| 480 | 720 | 45 | 30 | 6 | 3 | 30 | 4:3 | 4, 5 | I |
| 480 | 704 | 44 | 30 | 6 | 5 | 30 | 16:9 | 1, 2, 4, 5 | P |
| 480 | 704 | 44 | 30 | 6 | 3 | 30 | 4:3 | 1, 2, 4, 5 | P |
| 480 | 704 | 44 | 30 | 6 | 5 | 30 | 16:9 | 4, 5 | I |
| 480 | 704 | 44 | 30 | 6 | 3 | 30 | 4:3 | 4, 5 | I |
| 480 | 640 | 40 | 30 | 6 | 1 | 30 | 4:3 | 1, 2, 4, 5 | P |
| 480 | 640 | 40 | 30 | 6 | 1 | 30 | 4:3 | 4, 5 | I |
| 480 | 544 | 34 | 30 | 6 | 5 | 30 | 4:3 | 1, 4 | P |
| 480 | 544 | 34 | 30 | 6 | 5 | 30 | 4:3 | 4 | I |
| 480 | 528 | 33 | 30 | 6 | 5 | 30 | 4:3 | 1, 4 | P |
| 480 | 528 | 33 | 30 | 6 | 5 | 30 | 4:3 | 4 | I |
| 480 | 352 | 22 | 30 | 6 | 7 | 30 | 4:3 | 1, 4 | P |
| 480 | 352 | 22 | 30 | 6 | 7 | 30 | 4:3 | 4 | I |

Legend:
frame rate: 1 = 23.976 Hz, 2 = 24 Hz, 4 = 29.97 Hz, 5 = 30 Hz, 7 = 59.94 Hz, 8 = 60 Hz
aspect_ratio_idc: 1 = 1:1 [square samples], 3 = 10:11, 5 = 40:33, 7 = 20:11, 14 = 4:3

TABLE 2
(HD)

| | | | | MaxFrameBuffers | | | | | |
|---|---|---|---|---|---|---|---|---|---|
| vertical | horizontal | PicWidth | PicHeight | Error! Reference | aspect_{—} | level_{—} | Display | Allowed | Progressive |
| size | size | (MBs) | (MBs) | source not found. | ratio_idc | idc | aspect ratio | frame rates | interlaced |
| 1080 | 1920 | 120 | 68 | 4 | 1 | 40 | 16:9 | 1, 2, 4, 5 | P |
| 1080 | 1920 | 120 | 68 | 4 | 1 | 40 | 16:9 | 4, 5 | I |
| 1080 | 1440 | 90 | 68 | 4 | 14 | 40 | 16:9 | 1, 2, 4, 5 | P |
| 1080 | 1440 | 90 | 68 | 4 | 14 | 40 | 16:9 | 4, 5 | I |
| 720 | 1280 | 80 | 45 | 9 | 1 | 40 | 16:9 | 1, 2, 4, 5, 7, 8 | P |
| 480 | 720 | 45 | 30 | 9 | 5 | 40 | 16:9 | 7, 8 | P |
| 480 | 720 | 45 | 30 | 9 | 3 | 40 | 4:3 | 7, 8 | P |
| 480 | 704 | 44 | 30 | 9 | 5 | 40 | 16:9 | 7, 8 | P |
| 480 | 704 | 44 | 30 | 9 | 3 | 40 | 16:9 | 7, 8 | P |
| 480 | 640 | 40 | 30 | 9 | 1 | 40 | 4:3 | 7, 8 | P |
| 1080 | 1920 | 120 | 68 | 4 | 1 | 42 | 16:9 | 7, 8 | P |
| 1080 | 1440 | 90 | 68 | 4 | 14 | 42 | 16:9 | 7, 8 | P |

Legend:
frame rate: 1 = 23.976 Hz, 2 = 24 Hz, 4 = 29.97 Hz, 5 = 30 Hz, 7 = 59.94 Hz, 8 = 60 Hz
aspect_ratio_idc: 1 = 1:1 [square samples], 3 = 10:11, 5 = 40:33, 7 = 20:11, 14 = 4:3

One example of an appropriate descriptor (e.g., for use in a PMT and including the information from tables 1 and 2 above) is as follows:

| Syntax | No. of bits |
|---|---|
| descriptor_tag | 8 |
| descriptor_length | 8 |
| main_format_index | 8 |
| aux_format_info_length | 8 |

for (i=0;i<aux_format_info_length;i++) {

| | |
|---|---|
| aux_format_index[i] | 1 |
| } | |

if(aux_format_length%8 != 0) {

for (j=0;j<8-(aux_format_length%8);j++) {

| | |
|---|---|
| padding | 1 |
| } | |

}

In one embodiment, a single reference table is envisioned, such as a concatenation of tables 1 and 2 below, indexed as appropriate (e.g., from 0 to 28, though a different quantity (e.g., greater) of formats and hence indices are contemplated). The format may be indexed by the main_format_index is the intended output picture format. Apart from that, it is not distinguished from the auxiliary formats, in that they all are together the set of anticipated picture formats. In one embodiment, if aux_format_index[i] is ‘1 ’, then the format indexed by i is anticipated and possible, otherwise it is not possible or anticipated and not to be expected by the decoder. The mere presence of this auxiliary information may communicate one to several picture formats or respective piece of picture format information in this example descriptor: (1) there is a preferred or designated intended output picture format; (2) the DPB may be configured once for the associated video stream with a fixed number of frames (Q) with a picture size large enough in memory to accommodate all of the anticipated picture formats, including the main format and expected auxiliary formats; and though smaller picture sizes would not cause reconfiguring the DPB into a greater quantity (R) of smaller frames, the video stream received by the VSRP device 200 can be expected for this video service to never exceed Q DPB frames; and/or (3) all possible incoming video or picture formats are known. In other words (as to #3), any format not indicated in either the main_format_index or an aux_format_index is not expected. Variations for the above signaled picture information or different descriptors or signalling mechanisms with similar or different conveyances are contemplated.

The STS 100 may comprise an IPTV network, a cable television network, a satellite television network, or a combination of two or more of these networks or other networks. Further, network PVR and switched digital video are also considered within the scope of the disclosure. Although described in the context of video processing, it should be understood that certain embodiments of the VP systems described herein also include functionality for the processing of other media content such as compressed audio streams.

The STS 100 comprises additional components and/or facilities not shown, as should be understood by one having ordinary skill in the art. For instance, the STS 100 may comprise one or more additional servers (Internet Service Provider (ISP) facility servers, private servers, on-demand servers, channel change servers, multi-media messaging servers, program guide servers), modulators (e.g., QAM, QPSK, etc.), routers, bridges, gateways, multiplexers, transmitters, and/or switches (e.g., at the network edge, among other locations) that process and deliver and/or forward (e.g., route) various digital services to subscribers.

In one embodiment, the VP system comprises the headend 110 and one or more of the VSRP devices 200. In some embodiments, the VP system comprises portions of each of these components, or in some embodiments, one of these components or a subset thereof. In some embodiments, one or more additional components described above yet not shown in FIG. 1 may be incorporated in a VP system, as should be understood by one having ordinary skill in the art in the context of the present disclosure.

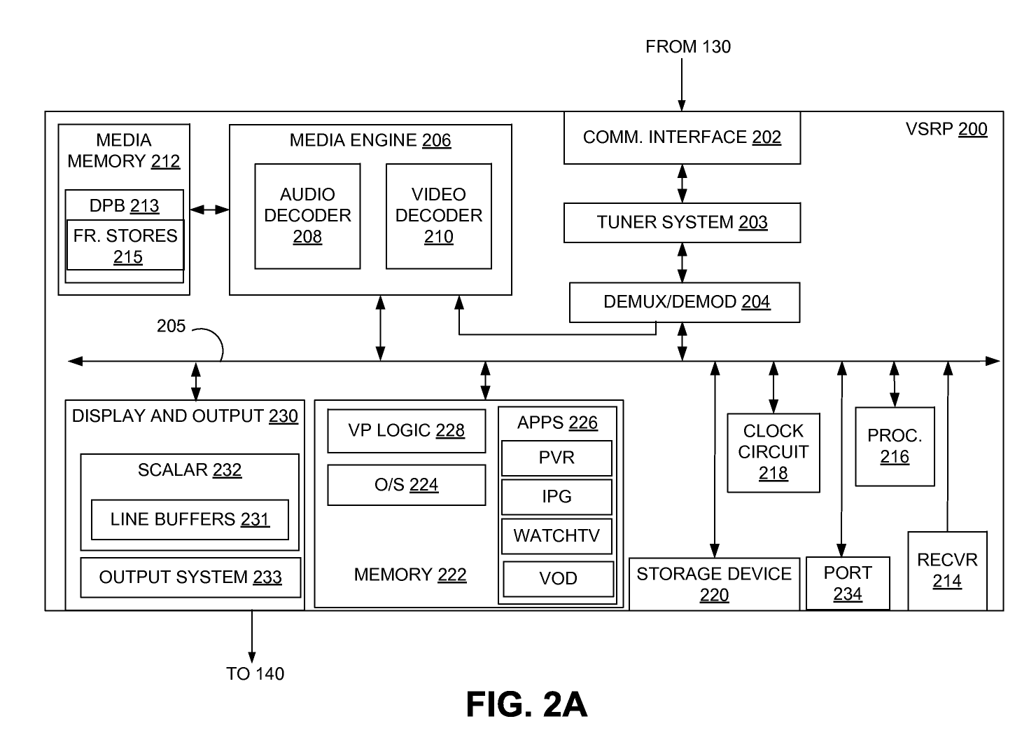

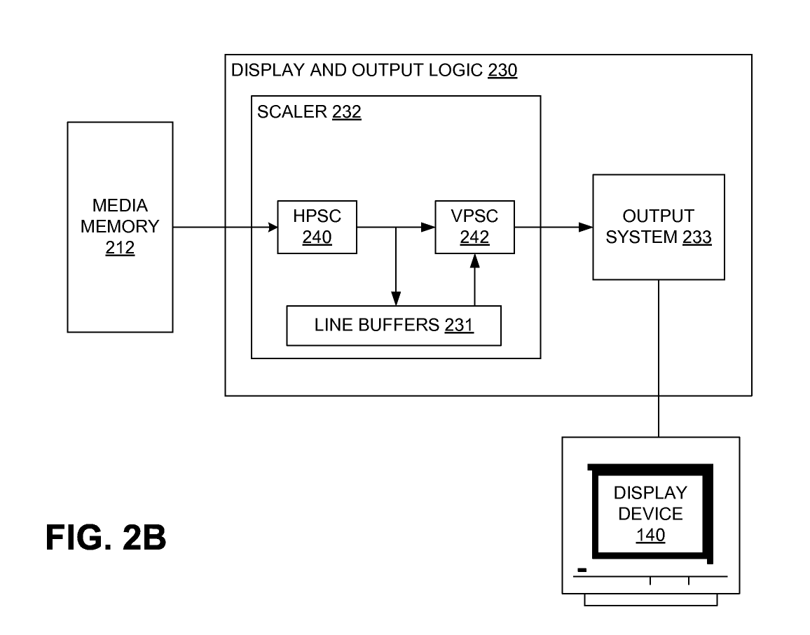

FIG. 2A is an example embodiment of select components of a VSRP device 200. It should be understood by one having ordinary skill in the art that the VSRP device 200 shown in FIG. 2A is merely illustrative, and should not be construed as implying any limitations upon the scope of the disclosure. In one embodiment, a VP system may comprise all components shown in, or described in association with, the VSRP device 200 of FIG. 2A. In some embodiments, a VP system may comprise fewer components, such as those limited to facilitating and implementing the decoding of compressed video streams and/or output processing of decompressed video streams. In some embodiments, functionality of the VP system may be distributed among the VSRP device 200 and one or more additional devices as mentioned above.

The VSRP device 200 includes a communication interface 202 (e.g., depending on the implementation, suitable for coupling to the Internet, a coaxial cable network, an HFC network, satellite network, terrestrial network, cellular network, etc.) coupled in one embodiment to a tuner system 203. The tuner system 203 includes one or more tuners for receiving downloaded (or transmitted) media content. The tuner system 203 can select from a plurality of transmission signals provided by the STS 100 (FIG. 1). The tuner system 203 enables the VSRP device 200 to tune to downstream media and data transmissions, thereby allowing a user to receive digital media content via the STS 100. In one embodiment, analog TV signals can be received via tuner system 203. The tuner system 203 includes, in one implementation, an out-of-band tuner for bi-directional data communication and one or more tuners (in-band) for receiving television signals. In some embodiments (e.g., IPTV-configured VSRP devices), the tuner system may be omitted.

The tuner system 203 is coupled to a demultiplexing/demodulation system 204 (herein, simply demux 204 for brevity). The demux 204 may include MPEG-2 transport demultiplexing capabilities. When tuned to carrier frequencies carrying a digital transmission signal, the demux 204 enables the separation of packets of data, corresponding to the desired AVC stream, for further processing. Concurrently, the demux 204 precludes further processing of packets in the multiplexed transport stream that are irrelevant or not desired, such as packets of data corresponding to other video streams. Parsing capabilities of the demux 204 allow for the ingesting by the VSRP device 200 of program associated information carried in the transport packets. The demux 204 is configured to identify and extract information in the transport stream to facilitate the identification, extraction, and processing of the compressed pictures. Such information includes Program Specific Information (PSI) (e.g., Program Map Table (PMT), Program Association Table (PAT), etc.) and parameters or syntactic elements (e.g., Program Clock Reference (PCR), time stamp information, payload_unit_start_indicator, etc.) of the transport stream (including packetized elementary stream (PES) packet information).

In one embodiment, additional information extracted by the demux 204 includes the aforementioned auxiliary information pertaining to picture formats associated with a video stream that assists the decoding logic (in cooperation with the processor 216 executing code of the VP logic 228 to interpret the extracted auxiliary information) in decompression of the compressed pictures of the video stream, and in some embodiments, further assists display and output logic 230 (in cooperation with the processor 216 executing code of the VP logic 228) in processing reconstructed pictures for display and/or output. In some embodiments, the VP logic 228 and/or the aforementioned decoding and/or output processing logic that receives the auxiliary information may opt to disregard or modify the auxiliary information. In one embodiment, the demux 204 is configured with programmable hardware (e.g., PES packet filters). In some embodiments, the demux 204 is configured in software, or a combination of hardware and software.

The demux 204 is coupled to a bus 205 and to a media engine 206. The media engine 206 comprises, in one embodiment, decoding logic comprising one or more of a respective audio decoder 208 and video decoder 210. The media engine 206 is further coupled to the bus 205 and to media memory 212, the latter which, in one embodiment, comprises one or more respective buffers for temporarily storing compressed (compressed picture buffer or bit buffer, not shown) and/or reconstructed pictures (decoded picture buffer or DPB 213). The DPB 213 includes multiple framestores 215, the quantity of which is configured and fixed for a currently tuned channel in advance of receiving pictures of a video stream in accordance with picture format information in the auxiliary information received from an upstream device as explained further below. In some embodiments, one or more of the buffers of the media memory 212 may reside in other memory (e.g., memory 222, explained below) or components.

The VSRP device 200 further comprises additional components coupled to the bus 205 (though shown as a single bus, one or more buses are contemplated to be within the scope of the embodiments). For instance, the VSRP device 200 further comprises a receiver 214 (e.g., infrared (IR), radio frequency (RF), etc.) configured to receive user input (e.g., via direct-physical or wireless connection via a keyboard, remote control, voice activation, etc.) to convey a user's request or command (e.g., for program selection, stream manipulation such as fast forward, rewind, pause, channel change, display screen format preference via an interactive session, etc.), one or more processors (one shown) 216 for controlling operations of the VSRP device 200, and a clock circuit 218 comprising phase and/or frequency locked-loop circuitry to lock into a system time clock (STC) from a program clock reference, or PCR, received in the video stream to facilitate decoding and output operations. Explicit PTS/DTS values and extrapolated values (for PTS and DTS) are compared to the reconstructed STC (generated by the clock circuit 218) to enable a determination of when the buffered compressed pictures are provided to the video decoder 210 for decoding (DTS) and when the buffered, decoded pictures are output by the video decoder 210 (PTS) to display and output logic 230 for processing and subsequent presentation on a display device 140. In some embodiments, clock circuit 218 may comprise plural (e.g., independent or dependent) circuits for respective video and audio decoding operations and output processing operations. Although described in the context of hardware circuitry, some embodiments of the clock circuit 218 may be configured as software (e.g., virtual clocks) or a combination of hardware and software. Further, in some embodiments, the clock circuit 218 is programmable.

The VSRP device 200 may further comprise a storage device 220 (and associated control logic as well as one or more drivers in memory 222) to temporarily store buffered media content and/or more permanently store recorded media content. The storage device 220 may be coupled to the bus 205 via an appropriate interface (not shown), as should be understood by one having ordinary skill in the art.

Memory 222 in the VSRP device 200 comprises volatile and/or non-volatile memory, and is configured to store executable instructions or code associated with an operating system (O/S) 224 and other applications, and one or more applications 226 (e.g., interactive programming guide (IPG), video-on-demand (VOD), personal video recording (PVR), WatchTV (associated with broadcast network TV), among other applications not shown such as pay-per-view, music, driver software, etc.).

Further included in one embodiment in memory 222 is video processing (VP) logic 228, which in one embodiment is configured in software. In some embodiments, VP logic 228 may be configured in hardware, or a combination of hardware and software. The VP logic 228, in cooperation with the processor 216, is responsible for interpreting auxiliary information and configuring the allocation of framestores 215 responsive to the auxiliary information, as well as providing the appropriate settings for a display and output system 230 of the VSRP device 200. In some embodiments, functionality of the VP logic 228 may reside in another component within or external to memory 222 or be distributed among multiple components of the VSRP device 200 in some embodiments.

The VSRP device 200 is further configured with the display and output logic 230, as indicated above, which includes a scalar 232, line buffers 231, and one or more output systems (e.g., configured as HDMI, DENC, or others well-known to those having ordinary skill in the art) 233 to process the decoded pictures and provide for presentation (e.g., display) on display device 140. In some embodiments, the scalar 232 may be configured as one or more sample rate converters. FIG. 2B shows a block diagram of one embodiment of the display and output logic 230. It should be understood by one having ordinary skill in the art that the display and output logic 230 shown in FIG. 2B is merely illustrative, and should not be construed as implying any limitations upon the scope of the disclosure. For instance, in some embodiments, the display and output logic 230 may comprise a different arrangement of the illustrated components and/or additional components not shown, including additional memory, processors, switches, clock circuits, filters, and/or samplers, graphics pipeline, among other components as should be appreciated by one having ordinary skill in the art in the context of the present disclosure. Further, though shown conceptually in FIG. 2A as an entity separate from the media engine 206, in some embodiments, one or more of the functionality of the display and output logic 230 may be incorporated in the media engine 206 (e.g., on a single chip) or elsewhere in some embodiments. As explained above, the display and output logic 230 comprises in one embodiment the scalar 232 and one or more output systems 233 coupled to the scalar 232 and the display device 140. The scalar 232 comprises a display pipeline including a Horizontal Picture Scaling Circuit (HPSC) 240 configured to perform horizontal scaling, and a Vertical Scaling Picture Circuit (VPSC) 242 configured to perform vertical scaling. In one embodiment, the input of the VPSC 242 is coupled to internal memory corresponding to one or more line buffers 231, which are connected to the output of the HPSC 240. The line buffers 231 serve as temporary repository memory to effect scaling operations.

In one embodiment, under synchronized video timing and employment of internal FIFOs (not shown), reconstructed pictures may be read from the DPB and provided in raster scan order, fed through the scalar 232 to achieve the horizontal and/or vertical scaling instructed in one embodiment by the auxiliary information, and the scaled pictures are provided (e.g., in some embodiments through an intermediary such as a display buffer located in media memory 212) to the output port 233 according to the timing of a physical clock (e.g., in the clock circuit 218 or elsewhere) driving the output system 233. In some embodiments, vertical downscaling may be implemented by neglecting to read and display selected video picture lines in lieu of processing by the VPSC 242. In some embodiments, upon a change in the vertical resolution of the picture format, vertical downscaling may be implemented to all, for instance where integer decimation factors (e.g., 2:1) are employed, by processing respective sets of plural lines of each picture and converting them to a corresponding output line of the output picture. In some embodiments, non-integer decimation factors may be employed for vertical subsampling (e.g., using in one embodiment sample-rate converters that require the use of multiple line buffers in coordination with the physical output clock that drives the output system 233 to produce one or more output lines). Note that the picture resolution output via the output system 233 may differ from the native picture resolution (prior to encoding) or the intended output picture format of a video stream that is signaled in the auxiliary information. Other forms of scaling may entail writing read DPB frames back to media memory 212.

In some embodiments, the output picture resolution throughout the entirety of decoding a video stream that has plural picture formats is kept constant because the pixel aspect ratio for each of the picture formats in the video stream changes accordingly to maintain the output picture resolution a constant.

Referring once again to FIG. 2A, a communications port 234 (or ports) is (are) further included in the VSRP device 200 for receiving information from and transmitting information to other devices. For instance, the communication port 234 may feature USB (Universal Serial Bus), Ethernet, IEEE-1394, serial, and/or parallel ports, etc. The VSRP device 200 may also include one or more analog video input ports for receiving and/or transmitting analog video signals.

One having ordinary skill in the art should understand that the VSRP device 200 may include other components not shown, including decryptors, samplers, digitizers (e.g., analog-to-digital converters), multiplexers, conditional access processor and/or application software, driver software, Internet browser, among others. Further, though the VP logic 228 is illustrated as residing in memory 222, it should be understood that all or a portion of such logic 228 may be incorporated in, or distributed among, the media engine 206, the display and output system 230, or elsewhere. Similarly, in some embodiments, functionality for one or more of the components illustrated in, or described in association with, FIG. 2A may be combined with another component into a single integrated component or device.

As indicated above, the VSRP device 200 includes a communication interface 202 and tuner system 203 configured to receive an A/V program (e.g., on-demand or broadcast program) delivered as a sequence of compressed pictures of a video stream. The discussion of the following flow diagrams assumes a stream transition corresponding to, for instance, a user- or system-prompted channel change event, resulting in the transmittal from the headend 110 and reception by the VSRP device 200 of auxiliary information pertaining to picture formats in advance of the entry point in a video stream where the video decoder starts decoding. In one embodiment, this point corresponds to a random access point. The auxiliary information is also provided prior to the point in the video stream corresponding to a change in picture formats. That is, prior to a transition of the compressed pictures at one interval comprising a first picture size or resolution corresponding to a first picture format and at another interval (e.g., for transmission of a commercial or advertisement) comprising a second picture size or resolution corresponding to a second picture format. Although the video format change (e.g., change in picture format) examples described below emphasize the picture size (e.g., resolution), it should be understood that other picture format parameters included within the scope of the disclosure include in addition to, or in lieu of picture size, one or more of picture rate, scan format (interlaced or progressive), and picture aspect ratio, and/or pixel aspect ratio. Further, although described below in the context of HD and AVC, the disclosed embodiments are applicable to other video standards/specifications, signal formats, profiles, and/or levels.

In addition, the parameters the VP system embodiments detect in the transport stream to facilitate identification and extraction are based on an assumption of MPEG-2 transport, with the understanding that other mechanisms not requiring parameter extraction from the video coding layer are contemplated to be within the scope of the embodiments. For instance, auxiliary information may reside in a packet header for which IPTV application software in the VSRP device 200 is configured to receive and process in some embodiments (i.e., without extraction from a transport stream). Further, in some embodiments, extraction from non-transport layers may be implemented and hence contemplated to be within the scope of the embodiments.

The VP system (e.g., encoder 111, splicer 112, decoding logic (e.g., media engine 206), and/or display and output logic 230) may be implemented in hardware, software, firmware, or a combination thereof. To the extent certain embodiments of the VP system or a portion thereof are implemented in software or firmware (e.g., including the VP logic 228), executable instructions for performing one or more tasks of the VP system are stored in memory or any other suitable computer readable medium and executed by a suitable instruction execution system. In the context of this document, a computer readable medium is an electronic, magnetic, optical, or other physical device or means that can contain or store a computer program for use by or in connection with a computer related system or method.

To the extent certain embodiments of the VP system or portions thereof are implemented in hardware, the VP system may be implemented with any or a combination of the following technologies, which are all well known in the art: a discrete logic circuit(s) having logic gates for implementing logic functions upon data signals, an application specific integrated circuit (ASIC) having appropriate combinational logic gates, programmable hardware such as a programmable gate array(s) (PGA), a field programmable gate array (FPGA), etc.

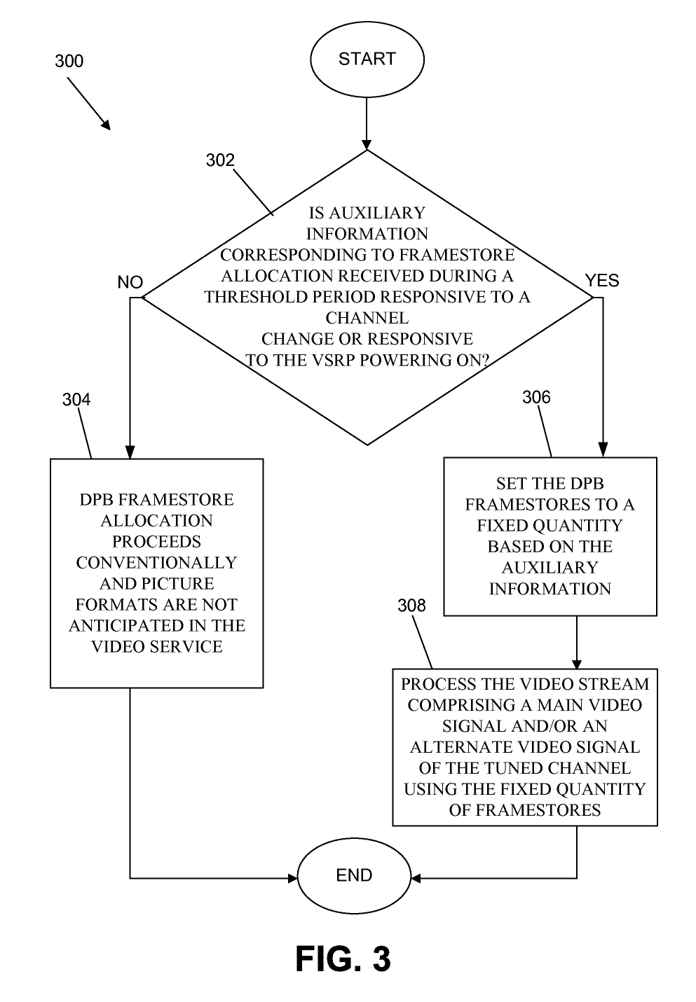

FIG. 3 is a flow diagram that illustrates one embodiment of a VP method 300 implemented at the VSRP device 200. Subsequent to the “start,” the VSRP device 200 determines whether auxiliary information corresponding to framestore allocation (e.g., signalling in the form of auxiliary information that directly or indirectly conveys to the VSRP device 200, after a channel change yet in advance of a picture format change or the entry point in the video stream designated to start picture processing (e.g., random access point), that the number of pictures slated for the DPB is to remain fixed and with a common picture resolution that is explicitly conveyed by the auxiliary information or implied, providing a basis for allocating a fixed quantity of framestores) is received during a threshold period responsive to a channel change or responsive to the VSRP 200 powering on (e.g., the user turns on the TV set via the VSRP 200) (302). In one embodiment, the threshold period is at least inversely proportional to the frequency of reception of a PMT, though other threshold periods may be used.

Responsive to a determination that no auxiliary information is received (“No” in FIG. 3), DPB framestore allocation proceeds conventionally and picture formats are not anticipated in the video service (304).

Responsive to a determination that the auxiliary information is received (“Yes” in FIG. 3), the VSRP 200 sets the DPB framestores to a fixed quantity based on the auxiliary information (306), and then processes (e.g., decodes) the video stream comprising a main video signal and/or an alternate video signal of the tuned channel using the fixed quantity of framestores (308). Changes in the picture format (e.g., size, though other picture format changes such as rate, scan format, and/or pixel aspect ratio are contemplated as well), which may occur at an IDR picture (or associated with other picture types in some embodiments), are communicated in one embodiment by the sequence parameter set (SPS) or in some embodiments, other triggers in the transport stream or other stream(s) associated with the change in picture format sequence). The decoding logic of the VSRP device 200 decodes the compressed pictures according to the changed-to picture format (as well as changed-from picture format) while utilizing the fixed quantity of framestores and continues the same output picture format continuously while receiving the associated video source. The constant output picture format may be the intended output picture format signaled by the auxiliary information (e.g., corresponding to the main picture format of the video service), or a modified version (but never changes while receiving the video service) suitable for the display device 140.

In one embodiment, the auxiliary information may convey a fixed quantity of pictures (e.g., reference pictures and/or pictures yet to be displayed) for use in the DPB, where the fixed quantity of pictures is based on the largest picture size corresponding to the largest picture format required to support all of the formats among the main and alternate picture formats contemplated for transmission in the tuned channel, as explained above. For instance, consider the case where the main video signal of the tuned or accessed (current) channel comprises compressed pictures possessing a picture format of 1920×1088, and the alternate video signal comprises compressed pictures possessing a picture format of 1280×720. AVC Level 4.0 allows up to four (4) pictures in the DPB for 1920×1088 and up to nine (9) pictures in the DPB for 1280×720. Based on the maximum picture sizes contemplated when considering both the main and alternate video signals, the fixed quantity of pictures conveyed in the auxiliary information is four (4). Accordingly, the VSRP 200 allocates a quantity of four (4) framestores and maintains (e.g., based on periodical receipt of the auxiliary information) that framestore quantity as fixed regardless of whether the main or alternate video signals are received. Stated differently, the auxiliary information conveys to the VSRP device 200 that the quantity of pictures used in the DPB is to remain fixed at four (4), and hence framestore allocation is set and fixed at a quantity of four (4) based on the maximum quantity of pictures expected throughout transmission of the expected main and alternate video signals in the current channel. For instance, upon receipt of a sequence of compressed pictures corresponding to the alternate picture format (e.g., possessing a picture format of 1280×720), the VSRP device 200 allocates four (4) DPB framestores (instead of a framestore allocation based on nine (9) DPB pictures, which would be performed for a 1280×720 video source without changes in picture format) based on the instructions conveyed in the auxiliary information. Such mechanisms avoid the de-allocation and re-allocation of memory. Processing of the 1280×720 signal simply requires less memory space utilization per larger allocated framestore. Upon termination of the interval corresponding to transmission of the alternative picture format and commencement of an interval corresponding to transmission of the main picture format (e.g., as signaled by a SPS, the format change occurring coincident with an IDR picture), the fixed quantity of four (4) larger DPB framestores remains for use in processing the pictures of the portion of the video stream with the main picture format, again circumventing the need for framestore de-allocation and re-allocation. Thus, the allocation of framestores is fixed throughout the video stream, even when changing from the main to alternate picture format) until a channel change (where the process 300 repeats itself at 302) or instructed otherwise and the DPB is reconfigured.

In some embodiments, the framestore allocation may be automatically determined based on predetermined picture formats, such as the aforementioned tables provisioned in some embodiments by the auxiliary information, or by the constraints imposed by the AVC specification (e.g., the fact that the number of DPB pictures for 1920×1088 cannot exceed four (4)).

As another example exploiting the benefits of certain embodiments of the VP systems, a VSRP device 200 may tune to a channel that corresponds to content formatted at 1280×720, and a commercial is received at a picture format of 1920×1088. Such an event is handled without a perceptible glitch since the auxiliary information conveys in some embodiments that the main video signal is delivered at 1280×720 with four (4) DPB pictures. The VSRP device 200, based on interpretation of the auxiliary information, further determines that there will be times when the picture size is larger. In other words, the parameters included in some embodiments of the auxiliary information may indicate that the video stream is processed based on 1280×720 picture format, but that the eligible services include 1920×1088 and 1440×1088, and the auxiliary information may further convey how to configure the DPB frames and the output system 233 to the main output picture format during those intervals when the alternate video signals are transmitted and received.

Other applications where certain embodiments of the VP system are contemplated should be appreciated by one having ordinary skill in the art in the context of the present disclosure. For instance, certain embodiments of the VP system have application to implementations that may conventionally prohibit memory access (e.g., as managed by an O.S. memory manager) to address picture format changes during high priority threads (e.g., implementation where an interactive IPG is running, in one section of the IPG window, a video that invokes the need for de-allocation/re-allocation while running an on-line banking transaction in another window). As another example, certain embodiments of the VP system may be beneficially applied in unified memory architectures (e.g., one bus for memory access that can physically limit the amount of operations involving memory). Another example implementation ripe for application of certain embodiments of the VP system include advanced set-top or computing devices that enable multiple decode and tuning operations.

In general, recapping the above description, the auxiliary information is conveyed periodically. In one embodiment, the auxiliary information is embodied as a descriptor that indicates to the VSRP device 200 a fixed quantity of DPB frames with a common picture size is to be expected in the impending video stream transmitted in the current channel as well as the anticipated video picture formats, and that the quantity of DPB pictures is to remain unchanged for transmissions of the plural picture formats comprising the main or alternate picture formats. Based on the auxiliary information, the VSRP device 200 allocates a fixed quantity of framestores that also remains unchanged for transmissions of the main or alternate video signals on the current channel absent instructions to the contrary. In some embodiments, the adherence to the auxiliary information is optional (e.g., the VSRP device 200 may be configured to opt out of these instructions). Further, some embodiments provide the auxiliary information in every channel. In some embodiments, the auxiliary information is only transmitted in a subset of the available channels, or the provision of the auxiliary information for a given channel or time frame is optional.

Having addressed certain embodiments of VP systems that decode compressed pictures of a video stream based on the interpretation of auxiliary information and resultant configuration of resources, attention is directed to the use of the auxiliary information (or a separate and distinct piece of auxiliary information in some embodiments) to assist the processing of reconstructed video. An output clock (e.g., a clock residing in the clocking circuit 218 or elsewhere) residing in the VSRP device 200 drives the output of reconstructed pictures (e.g., with an output system 233 configured as HDMI or a DENC or other known output systems). The display and output logic 230 may operate in one of plural modes. In one mode, often referred to as passthrough mode, the VSRP device 200 behaves intelligently, providing an output picture format corresponding to the picture format determined upon the acquisition or start of a video service (such as upon a channel change) in union with the format capabilities of the display device 140 and user preferences. In a fixed mode (or also referred to herein as a non-passthrough mode), the output picture format is fixed by user input or automatically (e.g., without user input) based on what the display device 140 supports (e.g., based on interrogation by the set-top box of display device picture format capabilities). One problem that may arise in the absence of auxiliary information is that a change in picture format (e.g., between 1280×720 and 1920×1088) typically involves a tear-down (e.g., reconfiguration) of the physical clock. Related to this problem is that the picture format received at the input to the decoding logic may not be known until very late in the initialization and set-up of the decode and display (or output) pipeline, which adds time to channel-change times. Further, a change in the output stage's format for which the output system 233 drives an HDTV set (or TV set) may incur more time to effect the transition from the output picture format of the prior shown channel to the picture format of the newly acquired channel. This latter situation may also be referred to as output adjustment time in switching. In addition, if inserted advertisements have a different picture format than the intended picture format of a television service, then the output stage may be switching several times, creating disruptions in television viewing, and possibly upsetting the subscriber's viewing experience. One objective may be to avoid the tearing down of a physical clock, since such a tear down effects a glitch and delay in the video presentation much like a channel disruption on the screen. Another objective may be to provide picture format information in advance of the initialization and set-up of the decode and display (or output) pipeline.

In one embodiment, the splicer 112 and/or encoder 111 deliver auxiliary information for reception and processing by the display and output logic 230, the auxiliary information conveying to the display and output logic 230 that the intended picture output is to correspond to the picture format of the main picture format of the video service regardless of the possibility of transmittal and reception of alternate video signals (e.g., remains fixed in the midst of picture format changes experienced or potentially experienced in a tuned channel). For instance, in circumstances where auxiliary information conveys to the VSRP device 200 that an output of pictures is to be implemented according to a first picture format (corresponding to the main picture format of the associated video service), decoding of compressed pictures of a second picture format (e.g., corresponding to an alternate picture format) takes place based on the fixed framestores, and upscaling or downscaling is implemented by the display and output logic 230 to achieve an output according to the first picture format. In other words, based on the auxiliary information, the display and output logic 230 is configured for proper picture scaling from any of the picture formats received in the television service to enable the intended picture output set for the output system 233. The conveyance of the auxiliary information enables the VSRP device 200 to circumvent any “tear down” of the output clock (e.g., physical pixel clock).

The auxiliary information conveys the main picture format of the associated video stream as the intended picture output format, including one or more of the following parameters: horizontal and/or vertical picture resolution, the picture rate, the scan format (e.g., progressive or interlaced), picture aspect ratio, and/or the pixel aspect ratio. As indicated above for the auxiliary information corresponding to fixed DPB framestores of a common size, the auxiliary information corresponding to the intended output picture format is transmitted in similar fashion (e.g., in a descriptor of the PMT, in a descriptor for an entire program, a descriptor for each iteration of an ES descriptor loop, or via other mechanisms for providing output picture formats). In some embodiments, the auxiliary information pertaining to the main picture output is provided responsive to a channel change event and in advance of the commencement of decoding. In one embodiment, such information may be provided in lieu of the auxiliary information pertaining to the fixed quantity of DPB pictures/expected alternate picture format information described above, and in some embodiments, such information may be provided in addition to the fixed picture/expected alternate picture format information in the same descriptor or separate descriptor or delivered according to a different mechanism or via a different channel or medium.

In some embodiments, the provision by the splicer 112 and/or encoder 111 of the auxiliary information and/or one or more of these parameters may be optional (e.g., omitted from one or more channels, or one or more programs or time intervals for one or more channels, etc.). In some embodiments, the display and output logic 230 may ignore all or a portion of the auxiliary information, or as mentioned above, may not receive auxiliary information (or a portion thereof) on one or more channels and/or during certain time frames in some embodiments.

As one example of an implementation using the auxiliary information to convey the picture format corresponding to the main video signal as the intended picture output, consider a picture format of 1920×1080 signaled as the main output picture format for the associated video stream and the alternate picture format corresponds to 1280×720. The auxiliary information may instruct the decoding logic to output both decoded picture formats when each is received (e.g., the decoded alternate picture format during one interval and the decoded pictures in the main picture format during another interval). In one embodiment, the 1280×720 video signal undergoes decoding (e.g., based on the fixed quantity of four (4) DPB pictures) and is upscaled to be presented for display at 1920×1080. That is, in one embodiment, upon reception of the 1280×720 video signal (e.g., an IDR picture commencing the beginning of the 1280×720 signal), the decoding logic processes the portion of the video stream based on the fixed quantity of pictures as instructed by the auxiliary information and based on the 1280×720 picture format (e.g., as signaled in the SPS), yet the display and output logic 230 accesses the decoded pictures from media memory 212 and upscales the decoded pictures to 1920×1080 (through the scalar 232 of the display pipeline) without tearing down the clock (e.g., pixel output clock) based on instructions from the auxiliary information.

The 1920×1088 compressed pictures, when received at the VSRP device 200, likewise are decoded based on the fixed four (4) DPB pictures as instructed in the auxiliary information and, for instance, the information provided in the SPS, and is processed by the display and output logic 230 for presentation also at 1920×1080 based on the auxiliary information. In other words, regardless of how the video stream is decoded for a given channel, the scalar 232 and output system 233 are configured prior to initialization of the decode and output processing and hence the decoded output is fixed at the main picture format as instructed by the auxiliary information.

Note that the benefits of certain embodiments of the VP systems disclosed herein are not limited to the client side of the subscriber television system 100. For instance, consider commercials and ad-insertion technology at the headend 110. In a cable network, national feeds are provided, such as FOX news, ESPN, etc. Local merchants may purchase times in these feeds to enable the insertion of local advertising. If FOX news channel is transmitted at 1280×720, and ESPN is transmitted at 1920×1088, one determination to consider in conventional systems is whether to provide the commercial in two formats, or select one while compromising the quality of the presentation in another. One benefit to the auxiliary information conveying the picture format or the main picture format corresponding to the associated video stream as the intended picture output format is that commercials may be maintained (e.g., in association with the upstream splicer 112) in one picture format, as opposed to two picture formats.

In some embodiments, as indicated above, the auxiliary information pertaining to the choice of picture format for output may be optional or disregarded by the VSRP device 200, such as when a subscriber or user has manually set the display formats, or an interrogation of the coupled display device renders the choice of picture format in the auxiliary information inappropriate, among other reasons. Also as indicated above, one or more of the picture formats may not be conveyed for one or more processes. For instance, in one embodiment, the pixel or picture aspect ratio is not conveyed in the auxiliary information for purposes of output and display processing, whereas in some embodiments, the pixel or picture aspect ratio is included (with or without other picture format parameters).

In some embodiments, picture format changes are allowed between television signals corresponding to high definition (HD) and television signals corresponding to standard definition (SD) formats only when the HD format corresponds to the main video signal format. That is, in some embodiments, SD-to-HD changes are not allowed. In HD-to-SD implementations, the VSRP device 200 sets aside a pre-allocated amount of memory as fixed (and retains as fixed throughout picture format changes) as explained above. Further, with regard to output processing (e.g., by the display and output logic 230), the memory for de-interlacing purposes (e.g., in raster scan format, not in common macroblock-type, framestores used for DPB frames), such as in media memory 212 or elsewhere, is allocated as fixed based on the auxiliary information and utilized for de-interlacing of the SD signal to facilitate higher quality upscaling operations based on spatial and temporal filters. An HD implementation hence allows commercials in SD format, yet retains the intended picture output according to the picture format of the main video signal and uses the interlacing memory to de-interlace the SD pictures in cooperation with the scaling process. In one embodiment, de-interlacing may require memory allocation pertaining to plural fields (e.g., five fields) to enable motion compensated de-interlacing. Thus, HD implementations allow SD formats as an alternate, and allocation forces interlaced memory to be allocated and retained as fixed for those (de-interlacing) purposes.

In short, the auxiliary information generally signals the intended output format of a television service, and/or conveys information that enables the quantity of framestores of the DPB to be fixed and their common picture size amidst picture format changes and/or indicates the possibility of transmission of different picture formats that can be provided in that television service. The decoding logic may reserve enough memory to handle the worst possible case (since it would be known a priori to the decoding logic as provided by the auxiliary information as part of the channel or television service acquisition process). The auxiliary information may both relieve the decoding logic from having to de-allocate and re-allocate memory at each of the plurality of picture format transitions in the television service, and avoid disruptions in the displayed television service by circumventing or mitigating physical output clock reconfigurations.

It should be emphasized that the above-described embodiments of the disclosure are merely possible examples, among others, of the implementations, setting forth a clear understanding of the principles of the disclosure. Many variations and modifications may be made to the above-described embodiments without departing substantially from the principles set forth herein. All such modifications and variations are intended to be included herein within the scope of the disclosure. In addition, the scope of the disclosure includes embodying the functionality of the embodiments of the invention in logic embodied in hardware and/or software-configured mediums.

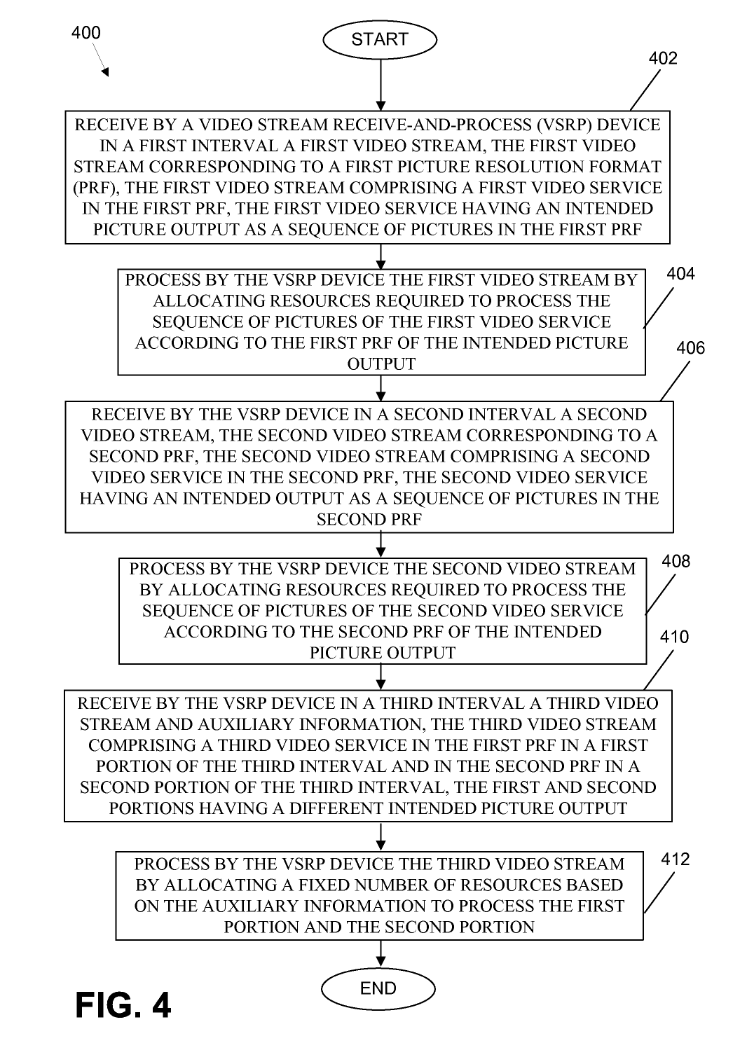

Having described various embodiments of VP system, it should be appreciated that one VP method embodiment 400, implemented at a VSRP device 200 and illustrated in FIG. 4, can be broadly described as receiving by a video stream receive-and-process (VSRP) device in a first interval a first video stream, the first video stream corresponding to a first picture resolution format (PRF), the first video stream comprising a first video service in the first PRF, the first video service having an intended picture output as a sequence of pictures in the first PRF (402); processing by the VSRP device the first video stream by allocating resources required to process the sequence of pictures of the first video service according to the first PRF of the intended picture output (404); receiving by the VSRP device in a second interval a second video stream, the second video stream corresponding to a second PRF, the second video stream comprising a second video service in the second PRF, the second video service having an intended output as a sequence of pictures in the second PRF (406); processing by the VSRP device the second video stream by allocating resources required to process the sequence of pictures of the second video service according to the second PRF of the intended picture output (408); receiving by the VSRP device in a third interval a third video stream and auxiliary information, the third video stream comprising a third video service in the first PRF in a first portion of the third interval and in the second PRF in a second portion of the third interval, the first and second portions having a different intended picture output (410); and processing by the VSRP device the third video stream by allocating a fixed number of resources based on the auxiliary information to process the first portion and the second portion (412).

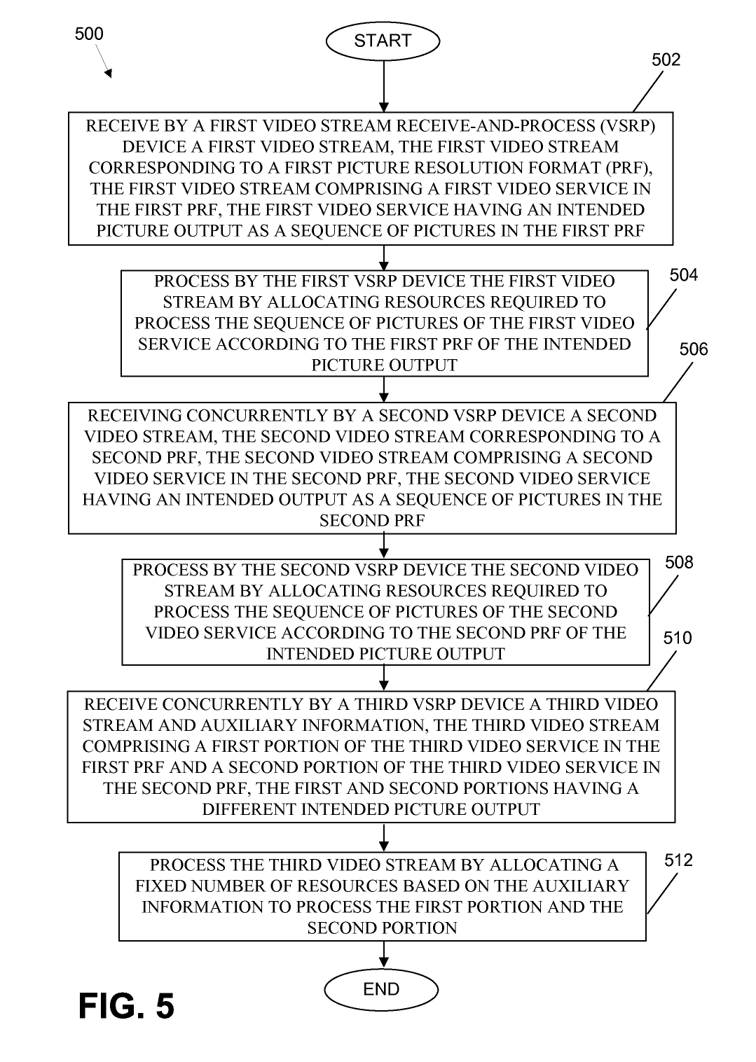

In view of the above description, it should be appreciated that another VP method embodiment 500, implemented by plural VSRP devices 200 and shown in FIG. 5, comprises receiving by a first video stream receive-and-process (VSRP) device a first video stream, the first video stream corresponding to a first picture resolution format (PRF), the first video stream comprising a first video service in the first PRF, the first video service having an intended picture output as a sequence of pictures in the first PRF (502); processing by the first VSRP device the first video stream by allocating resources required to process the sequence of pictures of the first video service according to the first PRF of the intended picture output (504); receiving concurrently by a second VSRP device a second video stream, the second video stream corresponding to a second PRF, the second video stream comprising a second video service in the second PRF, the second video service having an intended output as a sequence of pictures in the second PRF (506); processing by the second VSRP device the second video stream by allocating resources required to process the sequence of pictures of the second video service according to the second PRF of the intended picture output (508); receiving concurrently by a third VSRP device a third video stream and auxiliary information, the third video stream comprising a first portion of the third video service in the first PRF and a second portion of the third video service in the second PRF, the first and second portions having a different intended picture output (510); and processing the third video stream by allocating a fixed number of resources based on the auxiliary information to process the first portion and the second portion (512).

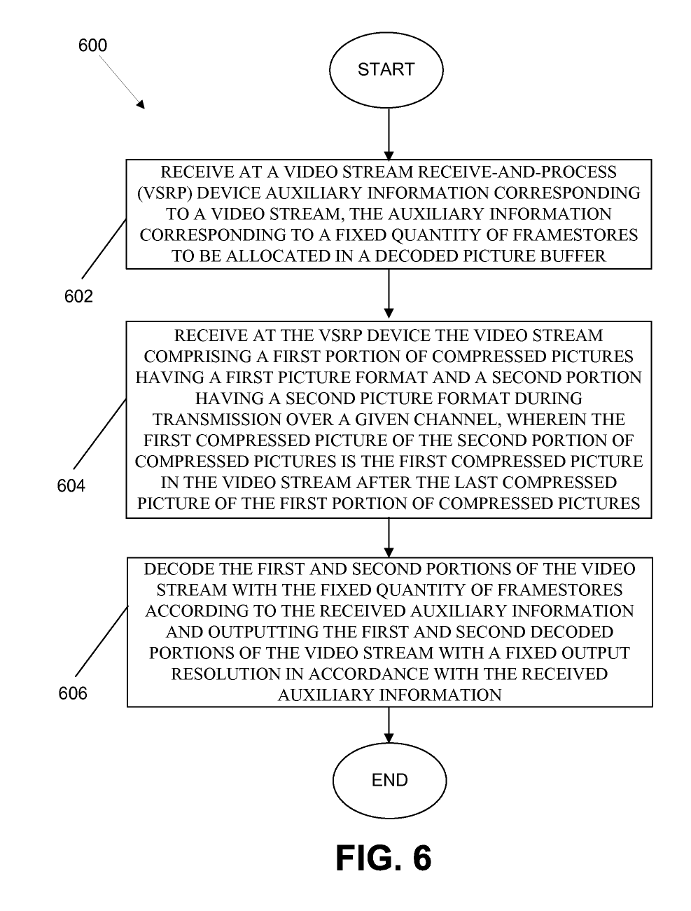

In view of the above description, it should be appreciated that another VP method embodiment 600, implemented by a VSRP device 200 and shown in FIG. 6, comprises receiving at a video stream receive-and-process (VSRP) device auxiliary information corresponding to a video stream, the auxiliary information corresponding to a fixed quantity of framestores to be allocated in a decoded picture buffer (602); receiving at the VSRP device the video stream comprising a first portion of compressed pictures having a first picture format and a second portion having a second picture format during transmission over a given channel, wherein the first compressed picture of the second portion of compressed pictures is the first compressed picture in the video stream after the last compressed picture of the first portion of compressed pictures (604); and decoding the first and second portions of the video stream with the fixed quantity of framestores according to the received auxiliary information and outputting the first and second decoded portions of the video stream with a fixed output resolution in accordance with the received auxiliary information (606).

In view of the above description, it should be appreciated that other VP method and/or system embodiments are contemplated. For instance, one VP method embodiment may be implemented upstream of the VSRP device (e.g., at the headend 110). In such an embodiment, the encoder 111 or splicer 112 may implement the steps of providing a transport stream comprising an encoded video stream that includes a first picture format for a first sequence of pictures and a second picture format for a second sequence of pictures, the first picture format different than the second picture format, and including in the transport stream auxiliary information that conveys to a downstream device a fixed quantity of pictures allocated in a decoded picture buffer for processing the first sequence of pictures and the second sequence of pictures. Other embodiments are contemplated as well.

Any process descriptions or blocks in flow charts or flow diagrams should be understood as representing modules, segments, or portions of code which include one or more executable instructions for implementing specific logical functions or steps in the process, and alternate implementations are included within the scope of the present disclosure in which functions may be executed out of order from that shown or discussed, including substantially concurrently or in reverse order, depending on the functionality involved, as would be understood by those reasonably skilled in the art. In some embodiments, steps of a process identified in FIGS. 3-6 using separate boxes can be combined. Further, the various steps in the flow diagrams illustrated in conjunction with the present disclosure are not limited to the architectures described above in association with the description for the flow diagram (as implemented in or by a particular module or logic) nor are the steps limited to the example embodiments described in the specification and associated with the figures of the present disclosure. In some embodiments, one or more steps may be added to one or more of the methods described in FIGS. 3-6, either in the beginning, end, and/or as intervening steps, and that in some embodiments, fewer steps may be implemented.

It should be emphasized that the above-described embodiments of the present disclosure are merely possible examples of implementations, merely set forth for a clear understanding of the principles of the VP systems and methods. Many variations and modifications may be made to the above-described embodiment(s) without departing substantially from the spirit and principles of the disclosure. Although all such modifications and variations are intended to be included herein within the scope of this disclosure and protected by the following claims, the following claims are not necessarily limited to the particular embodiments set out in the description.

What is claimed is:

1. A method, comprising:
receiving by a video stream receive-and-process (VSRP) device in a first interval a first video stream, the first video stream corresponding to a first picture resolution format (PRF), the first video stream comprising a first video service in the first PRF, the first video service having an intended picture output as a sequence of pictures in the first PRF;
processing by the VSRP device the first video stream by allocating resources required to process the sequence of pictures of the first video service according to the first PRF of the intended picture output;
receiving by the VSRP device in a second interval a second video stream, the second video stream corresponding to a second PRF, the second video stream comprising a second video service in the second PRF, the second video service having an intended output as a sequence of pictures in the second PRF;
processing by the VSRP device the second video stream by allocating resources required to process the sequence of pictures of the second video service according to the second PRF of the intended picture output;
receiving by the VSRP device in a third interval a third video stream and auxiliary information, the third video stream comprising a third video service in the first PRF in a first portion of the third interval and in the second PRF in a second portion of the third interval, the first and second portions having a different intended picture output; and
processing by the VSRP device the third video stream by allocating a fixed number of resources based on the auxiliary information to process the first portion and the second portion.

2. The method of claim 1, wherein the first and second PRF correspond to a main picture format.

3. The method of claim 1, wherein the first and second PRF correspond to plural anticipated picture formats.

4. The method of claim 1, wherein the first and second PRF correspond to a fixed number of decoded picture buffer (DPB) frames.

5. The method of claim 1, wherein the first and second PRF correspond to an intended output picture format.

6. The method of claim 1, wherein the auxiliary information conveys a sample aspect ratio.

7. The method of claim 1, wherein the auxiliary information conveys that the number or quantity K of decoded picture buffer (DPB) pictures is to remain constant and equal to a maximum number of DPB frames corresponding to a maximum picture size expected for a Level signaled in the third video stream, where K is a non-negative integer number.

8. The method of claim 1, wherein the first and second video streams lack auxiliary information of the type found in association with the third video stream.

9. The method of claim 1, wherein the resources comprise framestores of a decoded picture buffer (DPB).

10. The method of claim 1, wherein the auxiliary information is embodied as a transport layer descriptor in a table.

11. The method of claim 1, wherein the auxiliary information is embodied as a transport layer data field or data fields.

12. The method of claim 1, wherein the auxiliary information is conveyed as system information data.

13. The method of claim 1, further comprising fixing, in advance of decoding the third video stream, the output format for display of the pictures corresponding to the first and second portions of the processed third video stream.

14. The method of claim 1, further comprising outputting the pictures of the processed first and second video streams according to their respective intended picture output.

15. A method, comprising:
receiving by a first video stream receive-and-process (VSRP) device a first video stream, the first video stream corresponding to a first picture resolution format (PRF), the first video stream comprising a first video service in the first PRF, the first video service having an intended picture output as a sequence of pictures in the first PRF;
processing by the first VSRP device the first video stream by allocating resources required to process the sequence of pictures of the first video service according to the first PRF of the intended picture output;
receiving concurrently by a second VSRP device a second video stream, the second video stream corresponding to a second PRF, the second video stream comprising a second video service in the second PRF, the second video service having an intended output as a sequence of pictures in the second PRF;
processing by the second VSRP device the second video stream by allocating resources required to process the sequence of pictures of the second video service according to the second PRF of the intended picture output;
receiving concurrently by a third VSRP device a third video stream and auxiliary information, the third video stream comprising a first portion of the third video service in the first PRF and a second portion of the third video service in the second PRF, the first and second portions having a different intended picture output; and
processing the third video stream by allocating a fixed number of resources based on the auxiliary information to process the first portion and the second portion.

16. The method of claim 15, wherein the first and second PRF correspond to a main picture format, plural anticipated picture formats, a fixed number of decoded picture buffer (DPB) frames, an intended output picture format, sample aspect ratio, or a combination of two or more.

17. The method of claim 15, wherein the auxiliary information conveys at a transport level encapsulating the third video stream that the number or quantity K of decoded picture buffer (DPB) pictures is to remain constant and equal to a maximum number of DPB frames corresponding to a maximum picture size expected for a Level signaled in the third video stream, where K is a non-negative integer number.

18. The method of claim 15, wherein the first and second video streams lack auxiliary information of the type found in association with the third video stream

19. The method of claim 15, further comprising:
fixing, in advance of decoding the third video stream, the output format for display of the pictures corresponding to the first and second portions of the third video stream in accordance to the auxiliary information;
outputting the first and second portions of the processed third video stream in accordance to the auxiliary information; and
outputting the pictures of the processed first and second video streams according to their respective intended picture output.

20. A method, comprising:
receiving at a video stream receive-and-process (VSRP) device auxiliary information corresponding to a video stream, the auxiliary information corresponding to a fixed quantity of framestores to be allocated in a decoded picture buffer;
receiving at the VSRP device the video stream comprising a first portion of compressed pictures having a first picture format and a second portion having a second picture format during transmission over a given channel, wherein the first compressed picture of the second portion of compressed pictures is the first compressed picture in the video stream after the last compressed picture of the first portion of compressed pictures; and
decoding the first and second portions of the video stream with the fixed quantity of framestores according to the received auxiliary information and outputting the first and second decoded portions of the video stream with a fixed output resolution in accordance with the received auxiliary information.
